(19) United States
(12) Patent Application Publication
(10) Pub. No.: US 2013/0031105 A1
(43) Pub. Date: Jan. 31, 2013

(54) Automated Ranking of Entities Based on Trade References

(71) Applicants: Jeffrey A. Stibel, Malibu, CA (US); Aaron B. Stibel, Malibu, CA (US); Judith Gentile Hackett, Malibu, CA (US)

(72) Inventors: Jeffrey A. Stibel, Malibu, CA (US); Aaron B. Stibel, Malibu, CA (US); Judith Gentile Hackett, Malibu, CA (US)

(73) Assignee: Credibility Corp

(21) Appl. No.: 13/558,293

(22) Filed: Jul. 25, 2012

Related U.S. Application Data
(60) Provisional application No. 61/513,517, filed on Jul. 29, 2011.

(51) Int. Cl. G06F 17/30

(52) U.S. Cl. 707/748; 707/E17.033

(57) ABSTRACT

Some embodiments perform automated entity ranking to accurately portray the influence that each ranked entity holds within a particular field, industry, region, or some combination thereof. The ranking is primarily derived based on the number of trade references obtained for a particular entity and the influence of those trade references. The rankings can be sold as informational commodities and can be compiled to produce lists of the most influential entities within a particular field, industry, region, or some combination thereof.

### CLAIM OF BENEFIT

This application claims the benefit of U.S. provisional application 61/513,517, entitled “Automated Entity Ranking”, filed Jul. 29, 2011. The contents of the provisional application 61/513,517 are hereby incorporated by reference.

### TECHNICAL FIELD

The present invention pertains to a system, methods, and software products for performing automated entity ranking.

### BACKGROUND

The Internet has made it easier than ever before to establish contact and to stay in contact with a variety of entities, whether the contact is for social reasons or for business reasons. Contact can be made to interact or otherwise communicate with friends and other businesses. This includes establishing contact with friends and businesses that are both previously known and unknown to the entity establishing contact. Contact with unknown entities can be initiated as a result of referrals, searching the Internet, or searching various social networking sites. Making contact with other unknown business entities is often performed in order to identify new opportunities, address needs, resolve issues, and streamline operations.

Social networking sites such as LinkedIn, Spoke, Avvo, Facebook, Twitter, and the like have simplified identifying and establishing contact with unknown entities. For instance, one can access a search field at any such site and enter the search term “widgets” with a zip code and the site presents a list of widget suppliers/manufacturers that are within the specified geographic region. However, these sites do not properly rank the listed entities such that someone can readily and easily decipher who are the most influential in a particular field, industry, or region.

In many instances, social networking sites rank entities using metrics and formulas that are easily manipulated and biased. Consequently, the presented rankings from these sites do not accurately reflect the actual rank or influence of the entities. Some such social networking sites attempt to rank entities based on the number of contacts they have established. However, this does not take into account who the contact partners are and what influence the contact partners have. As a result, a business entity can create a network of contacts with other business entities that it has no relation with in order to falsely bolster its ranking, thereby leading to easily manipulated rankings. Some social networking sites attempt to rank entities based on how closely they are connected to one's existing network contacts. For example, a first entity will be preferred over a second entity when the first entity is a contact of at least one other contact that is within one's network of contacts and the second entity has no relation to any other entity in the network of contacts. Still some service providers utilize search engine techniques to rank entities based on how often a particular entity is referenced by others. This is a poor indicator of an entity's influence because search engine techniques can potentially lead to promoting notoriety. Specifically, a particular business entity may be referenced by other entities because of its negative conduct and these references can improperly improve that particular business entity's ranking.

Ranking entities for the purpose of identifying those entities that are of prominent influence in particular fields, industries, regions, etc. is especially important to small businesses and new businesses. Small businesses and new businesses are often in need of business partners that can improve growth and expansion by fulfilling a variety of business needs such as manufacturing, supplying, marketing, shipping, financing, distributing, etc. Moreover, selecting the right partners improves a business' credibility and, in turn, improves the future prospects of that business. For example, partnering with reputable and reliable parts suppliers will likely result in a manufacturer producing higher quality goods which in turn reflect on the credibility of that manufacturer.

Accordingly, there is a need for new systems and methods that more accurately rank entities in order to truly account for the influence that each ranked entity holds within a particular field, industry, region, or some combination thereof. There is also a need to modify the rankings based on dynamically specified qualifications so that the ranking can be filtered or tuned according to various other criteria.

### SUMMARY OF THE INVENTION

It is an object of the present invention to define a system, methods, and computer software products to perform automated entity ranking to accurately portray the influence that each ranked entity holds within a particular field, industry, region, or some combination thereof. It is further an object to modify the rankings based on dynamically specified qualifications to filter the ranking according to various other criteria.

To perform the automated entity ranking, some embodiments aggregate and evaluate a set of factors that primarily include the trade references for a particular entity and the influence of those trade references. Other factors used in the computation of an entity's rank include social networking activity, credit scores, credibility scores, and financial data. The system and methods produce a ranking based on the set of factors to represent the influence carried by a particular entity. Moreover, the ranking is granularly produced such that the ranking can be dynamically modified based on different qualifications that include filtering per field, industry, geographic region, and some combination thereof. The system and methods further produce lists that convey a particular entity's ranking in relation to the ranking of other entities. These lists identify who the primary influential entities for a given set of qualifications are.

In some embodiments, the produced rankings and lists are sold as commodities to entities interested in ascertaining their own influence or the influence of other entities in different fields, industries, and geographic regions. The ranking and lists can then be used to identify contacts that can potentially assist in the growth, expansion, and exposure of a particular business entity.

In some embodiments, the system and methods leverage information from the rankings to identify actions that can be performed by an entity to improve its ranking. In some such embodiments, the system and methods identify commonality within the set of highest ranked entities meeting a particular set of qualifications. The commonality is then be used to derive the actions that an entity outside of the set of highest ranked entities can perform in order to improve its ranking.

### BRIEF DESCRIPTION OF THE DRAWINGS

In order to achieve a better understanding of the nature of the present invention a preferred embodiment of the automated entity ranking system and methods will now be described, by way of example only, with reference to the accompanying drawings in which:

FIG. 1 presents a process performed by the ranking system to derive the rank of a particular entity in accordance with some embodiments.

FIG. 2 conceptually illustrates deriving the ranking for a particular entity based on its trade references in accordance with some embodiments.

FIG. 3 presents an alternative process performed by the ranking system to derive the rank of a particular entity in accordance with some embodiments.

FIG. 4 presents a process performed by the ranking system to compile a qualified list by using one or more qualifications to filter ranked entities in accordance with some embodiments.

FIG. 5 conceptually illustrates compiling a qualified list by using one or more qualifications to filter ranked entities in accordance with some embodiments.

FIG. 6 presents a process performed by the ranking system to compile a qualified list based on the application of one or more qualifications to the trade references of the entities.

FIG. 7 illustrates a computer system with which some embodiments are implemented.

### DETAILED DESCRIPTION OF THE INVENTION

In the following detailed description, numerous details, examples, and embodiments of an automated entity ranking system and methods are set forth and described. As one skilled in the art would understand in light of the present description, the system and methods are not limited to the embodiments set forth, and the system and methods may be practiced without some of the specific details and examples discussed. Also, reference is made to the accompanying figures, which illustrate specific embodiments in which the invention can be practiced. It is to be understood that other embodiments can be used and structural changes can be made without departing from the scope of the embodiments herein described.

As used herein, an entity is defined to include individuals and businesses, wherein a business can be represented by its agents or representatives. A trade reference for a particular entity includes any other entity that directly or indirectly engages in business transactions with the particular entity. To differentiate between a contact and a trade reference, a third party verifies that the identified trade reference has actually engaged in business transactions with the particular entity or documentation is aggregated to detail the transactions between the entity and its trade reference. In other words, a trade reference includes any entity that can attest to another entity's creditworthiness and business reputation as a result of having conducting business with the other entity at some recent point in time. An entity engages in a business transaction with a particular entity when it regularly extends credit to the particular entity or regularly conducts commercial transactions with the particular entity. In contrast to a trade reference, a contact can be established with any entity so long as the other entity agrees to the contact. A contact is therefore unverified and a poor indicator of one's influence or rank as contacts can be established for reasons unrelated to an entity's business transactions.

A direct trade reference is a first degree trade reference, wherein a first degree trade reference is an entity that sells goods and services directly to another entity. Conversely, an indirect trade reference is a second degree trade reference, wherein a second degree trade reference represents an entity that indirectly engages in a business transaction with a particular entity through another entity by providing goods or services to that other entity that then directly engages in a business transaction with the particular entity.

Some embodiments provide an entity ranking system (hereinafter referred to as the ranking system) to perform automated entity ranking for the purpose of accurately portraying the influence that each ranked entity holds within a particular field, industry, region, or some combination thereof. In some embodiments, the ranking system performs the automated entity ranking by aggregating and evaluating a set of factors that include the trade references for a particular entity. Specifically, the entity rank for a particular entity is derived primarily based on the number of trade references that the particular entity has and the influence of each of those trade references. In some embodiments, other factors can be used in addition to the trade references to supplement the derived ranking or to produce a preliminary ranking for an entity that is then modified according to the number of trade references and influences of the trade references for that entity. Some such factors with which the preliminary ranking can be derived include credit scores, credibility scores, and financial data that are associated with an entity.

In some embodiments, the ranking system qualifies the derived ranking for a particular entity based on some categorical qualifications such as industry, geographic region, or some combination thereof. It should be apparent to one of ordinary skill that other qualifications can be used in addition to or instead of those enumerated above to further qualify the derived entity ranking. One such qualification includes social networking activity of an entity.

Ranking based on trade references eliminates much of the ability to falsify or manipulate one's ranking. Specifically, when ranking based on trade references, the resulting ranking is primarily dependent on verifiable forms of business interactions that one entity has had with its trade references, wherein the business interactions are verified through documentation or through other verification channels (e.g., Dun & Bradstreet Credibility). This is in direct contract to ranking entities simply based on established contacts, whereby there is no verified interaction between the two entities that have established contact with one another. Moreover, the amount of engagement between the entity and its trade references is a quantifiable measure for the degree of influence that the entity exerts on its trade references or derives from its trade references. In other words, an entity's ranking is not affected simply because it has an established contact with a large corporation such as Microsoft. Instead, the affect on the entity's ranking is determined based on verified interactions that the entity has with the corporation when the corporation is specified as a trade reference.

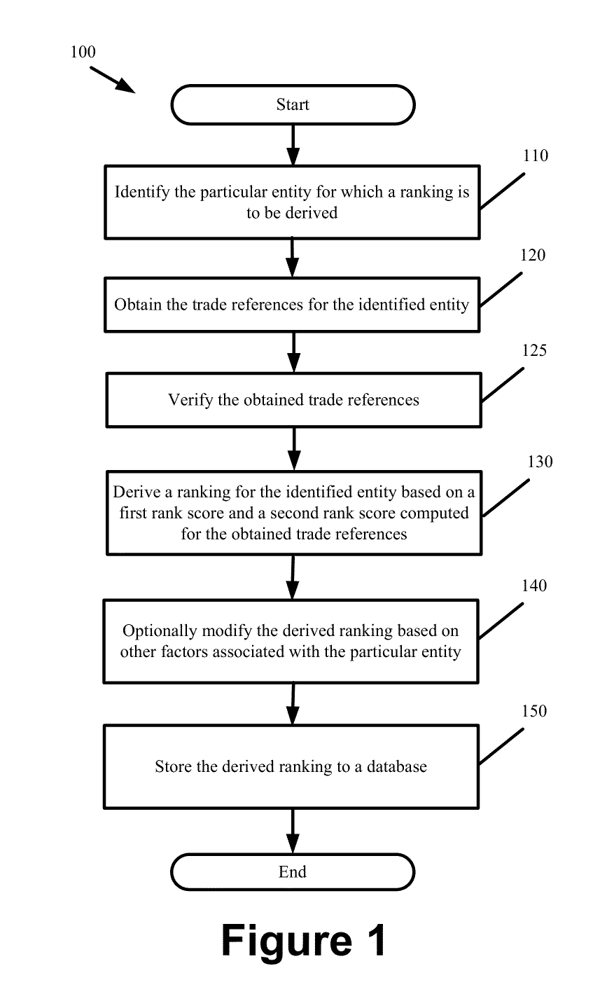

FIG. 1 presents a process 100 performed by the ranking system to derive the rank of a particular entity in accordance with some embodiments. The process 100 begins by identifying (at 110) the particular entity for which the ranking is to be derived. In some embodiments, the particular entity is identified when it registers with the ranking system or with some other platform that utilizes the ranking system functionality. For example, Dun & Bradstreet Credibility may integrate the ranking system such that when the particular entity registers for a Dun & Bradstreet Credibility good or service, the particular entity is identified to the ranking system. In some embodiments, the particular entity is identified by a unique identifier. The unique can comprise a DUNS® number, an employer identification number (EID), or a social security number as some examples. In some embodiments, identifying the entity further includes identifying a set of verified identification and classification information for the particular entity. Such information can be identified by using the unique identifier to query an entity database that stores the verified identification and classification information. The verified identification information identifies the particular entity through one or more of a name, address, telephone number, email address, and the like. The verified classification information qualifies the particular entity to a field of business, industry, and geographic region as some examples. Moreover, when the particular entity registers for a good or service, the particular entity may be required to disclose its trade references as part of the registration. For example, to obtain a ranking, a DUNS number, a credit report, or a credibility score, the platform integrated with the ranking system may require that the particular entity provide its trade references.

Accordingly, after identifying the particular entity, the process obtains (at 120) and verifies (at 125) the trade references for that particular entity. Trade reference submission can occur via online graphical user interfaces in which the particular entity enters information to identify the trade references and the interactions with those trade references. In some such embodiments, the particular entity may also submit any documentation that would assist in the verification of the trade references. Trade reference submission may also occur via telephone, whereby the particular entity contacts an agent of the ranking system in order to provide the trade reference information. The process for deriving the entity's ranking can be suspended until the trade references are provided and verified. In some embodiments, verifying a trade reference includes obtaining and confirming transactions between an entity and its trade reference based on receipts or invoices that document those transactions. In some embodiments, verifying a trade reference includes an agent of the ranking system or a third party contacting the specified trade reference on behalf of the ranking system to verify transactions between the entity and the trade references as well as amounts, payment, and other history relating to those transactions. Trade reference verification may also occur using a database that stores already obtained and verified trade references for various entities. The database may be maintained by the ranking system or by a third party such as Dun & Bradstreet Credibility. In such instances, the identifier for the particular entity is used to query against the database. The query identifies trade references that have been previously obtained and verified for the particular entity. Alternatively, the particular entity can specify identifiers for its trade references (e.g., name, address, etc.) and the identifiers can be queried against the database to verify the specified trade references are in fact trade references of the particular entity.

The process derives (at 130) a ranking for the identified particular entity based on the obtained trade references. In some embodiments, the ranking is composed of a first rank score and a second rank score.

The first rank score is computed based on the number of trade references that have been obtained for the particular entity. The number of trade references is one indicator for the scope of influence that the entity has. A highly influential entity will conduct business with a greater number of trade references than an entity with lesser influence and lesser exposure. Consequently, the greater the number of trade references, the higher the first rank score is. However, the derivation of the first rank score is also dependent on various factors such as the size of the particular entity. In other words, a large corporation having over one thousand employees will require a greater number of trade references than a small corporation having fewer than fifty employees in order to obtain the same first rank score as the small corporation. As such, the ranking system provides a set of rules that encode how the various factors (e.g., size of an entity) affect the derivation the first rank score from the number of trade references that are obtained for the particular entity. The data for these factors can be obtained from registration information that the particular entity provides to the ranking system or from information that is collected for the particular entity and stored to an entity database.

The second rank score is computed based on the rank computed for each trade reference of the particular entity. The ranking of the trade references may be computed using the same or similar process as process 100 with the computation occurring prior to or contemporaneously with the computation of the second rank score for the particular entity. When a ranking for a trade reference cannot be retrieved or derived, some embodiments substitute the ranking of the trade reference with a credit score or credibility score for the trade reference. The credit score or credibility score can be obtained from databases of credit reporting agencies that the ranking system is provided access to. In some embodiments, the process averages the rank of each trade reference to derive the second rank score. In some embodiments, the rank of each trade reference can have a disproportionate weight in the derivation of the second rank score. For example, the rank scores of trade references that have a large number of their own trade references will have a greater impact on the second rank score of the particular entity than the rank scores of trade references that have fewer numbers of their own trade references. The overall ranking for the identified entity is then derived based on the first rank score and the second rank score.

In some embodiments, the process modifies (at 140) the derived ranking based on other factors associated with the particular entity. Some such factors can include the credit score or credibility score of the particular entity. These scores can be obtained from an entity database or a credit reporting agency including TransUnion, Experian, Equifax, and Dun & Bradstreet Credibility. The platform that the ranking system is integrated with may include the entity databases and credit reporting database. Alternatively, the platform that the ranking system is integrated with may be engaged in partnerships with the platforms hosting the entity and credit reporting databases such that the ranking system is permitted access to such information. In some embodiments, modifying the derived ranking at step 140 can be optional and therefore omitted from the ranking derivation process 100.

The process stores (at 150) the derived ranking to a database of the ranking system and the process ends. Once stored to the database, the ranking can be provided to the entity for reference or used to compile lists that identify the most influential entities that satisfy a set of qualifications. In some embodiments, the ranking is stored in conjunction with classification information that was identified for the particular entity at 110. The classification information identifies the field, industry, and geographic region that the particular entity operates in. This information is used to modify the ranking based on various user or system specified qualifications as will be described below. In some embodiments, the ranking is stored in conjunction with the trade references for the particular entity. This information can also be used to modify the ranking based on specified qualifications.

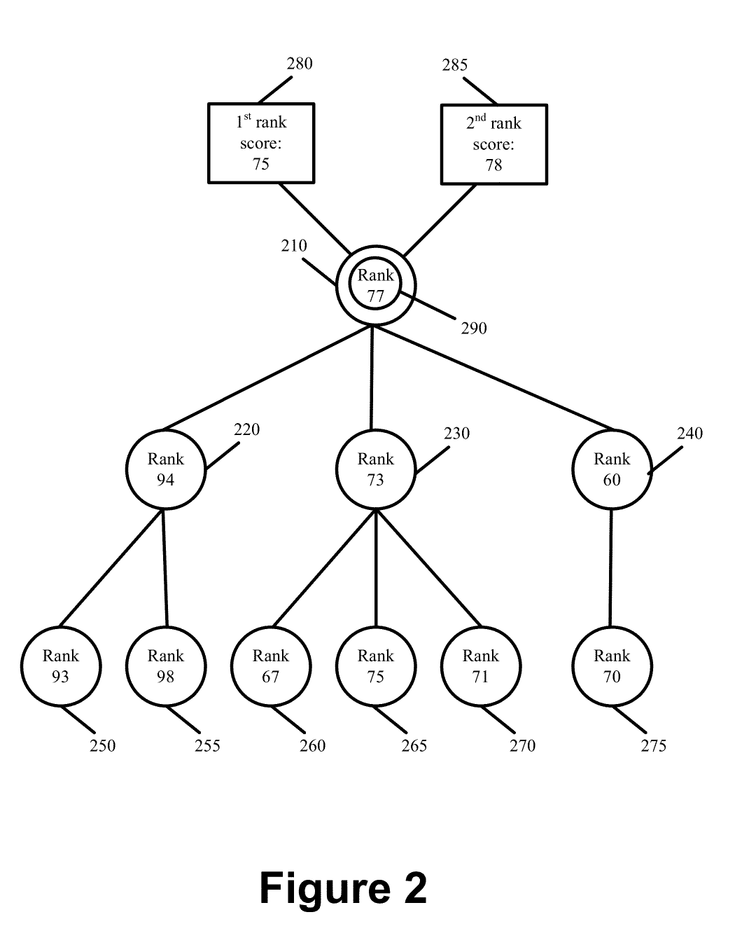

In accordance with some embodiments, FIG. 2 conceptually illustrates deriving the ranking for a particular entity based on its trade references. In FIG. 2, the root circle 210 represents the particular entity for which a ranking is to be derived, each circle 220, 230, and 240 at the child level represents a first degree trade reference of the particular entity, and each circle 250, 255, 260, 265, 270, and 275 at the grandchild level represents a second degree trade reference contact.

As noted above, the first rank component score 280 of the overall ranking 290 is derived based on the number of trade references for the particular entity. In this figure, the particular entity has three first degree trade references 220, 230, and 240 which results in a first rank component score of 75. The first rank component score 280 is a quantitative measure reflective of whether the particular entity has more or less first degree trade references than entities of similar characteristics such as size.

The second rank component score 285 of the overall ranking 290 is derived based on the rank of each of the trade references. In some embodiments, the rank for each of the trade references is derived in a manner similar to that of the particular entity. Specifically, the rank of trade reference 220 is derived based on the number of first degree trade references that trade reference 220 has (i.e., trade references 250 and 255) as well as the rank of each such trade reference. When such ranking information is not available for a particular trade reference then a credit score or credibility score can be used as a substitute for the ranking. As noted above, each trade reference may have a different proportional impact on the second rank component score 285. This may occur when each trade reference has a different number of its own first degree trade references indicative of varying degrees of influence. The first rank component score 280 and the second rank component score 285 are then used to derive the overall ranking 290 for the particular entity.

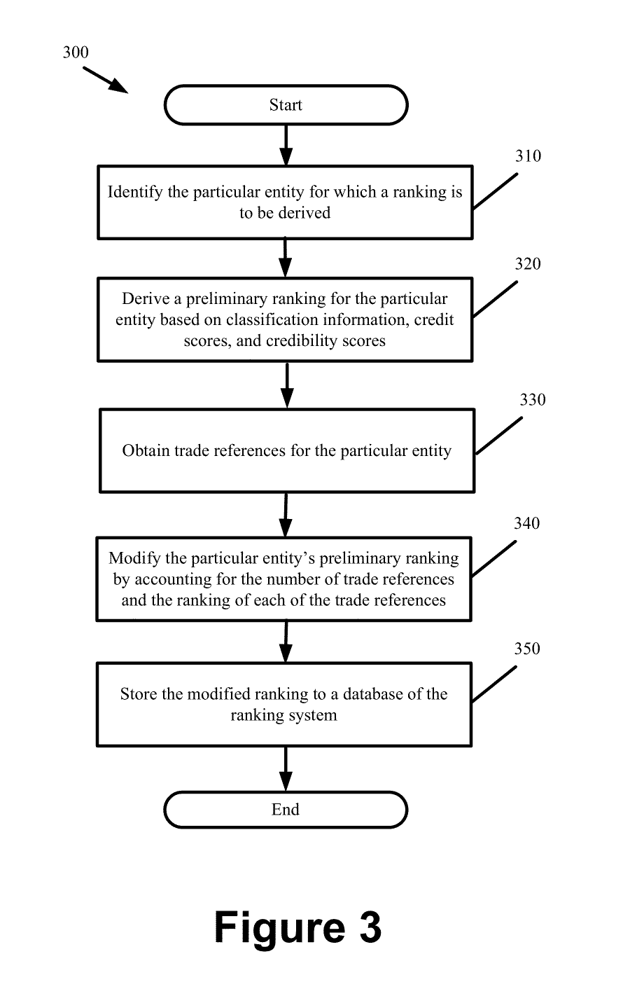

FIG. 3 presents an alternative process 300 performed by the ranking system to derive the rank of a particular entity in accordance with some embodiments. The process 300 begins by identifying (at 310) the particular entity for which the ranking is to be derived. Based on the entity identification, the process derives (at 320) a preliminary ranking for the particular entity based on one or more of the entity's credit scores and credibility scores. Specifically, a mapping routine may be used to convert credit scores and credibility scores into a preliminary ranking. The mapping routine may account for other factors like the size of the entity and the years the entity has been in existence such that the same credit score for different entities can result in a different preliminary rank. Irrespective as to how the preliminary rank is derived, the preliminary ranking may not accurately convey the ranking or influence of the particular entity, because the data used in computing the preliminary ranking can be unavailable, incomplete, or not representative of the particular entity's ranking. For example, the particular entity may be newly formed or sufficiently small in size such that the credit and credibility data for the particular entity cannot be determined or does not yet exist. Moreover, it may be the case that a business entity with a high credit score and a high credibility score may have little influence in the field, industry, or geographic region in which it operates. In other words, a ranking derived from credit scores and/or credibility scores is oftentimes inaccurate.

Therefore to obtain a more accurate rank for the particular entity, the process modifies the preliminary ranking according to the trade references of the particular entity. To do so, the process obtains (at 330) the trade references for the particular entity. In some embodiments, the trade references are obtained from an internal database of the ranking system, a database of the platform that the ranking system is integrated with, or a database of a third party that the ranking system is provided access to through a partnership agreement. The process modifies (at 340) the particular entity's preliminary ranking by accounting for the number of trade references and the ranking of each of the trade references.

The process stores (at 350) the modified ranking to a database of the ranking system and the process ends. In some embodiments, the modified ranking is stored in conjunction with classification information for the particular entity (e.g., the field, industry, and geographic region). In some embodiments, the modified ranking is stored in conjunction with the trade references for the particular entity.

In some embodiments, the rankings are commodities that are sold through the ranking system. For example, an entity is provided access to its or some other entity's ranking upon payment of a onetime fee or subscription fee.

In some embodiments, the ranking system utilizes the derived entity rankings to compile different qualified lists of the most influential entities. The lists can be qualified according to field, industry, geographic region, and any combination thereof. For example, these lists can identify who the top ten entities are that operate in a particular geographic region and in a particular industry. It should be apparent that other qualifications can be used in addition or instead of those enumerated above to compile different qualified lists.

The qualifications for a given list may be specified by a user interested in obtaining the qualified list. Additionally, the ranking system may automatically generate a set of qualified lists.

To derive a qualified list, some embodiments use the one or more specified qualifications to filter the ranked entities. The remaining entities that were not filtered out are then used to compile the qualified list based on their respective rankings. For example, a qualification may be specified to restrict entities to a specific geographic region. The ranking system then filters any entities that do not operate within the specific geographic region and identifies the ten remaining entities with the highest rankings.

Additionally or alternatively, some embodiments derive a qualified list by using the one or more specified qualifications to filter the trade references for each ranked entity. The rank for the entities is then recomputed based on the trade references that were not filtered out. For example, a qualification may be specified to restrict ranking derivation to a specific geographic region. The ranking system then filters the trade references for any entity to exclude any trade references not within the specific geographic region. Then, for each entity, the ranking system recomputes the ranking for the entity based on the trade references of that entity that have not been eliminated as a result of filtering.

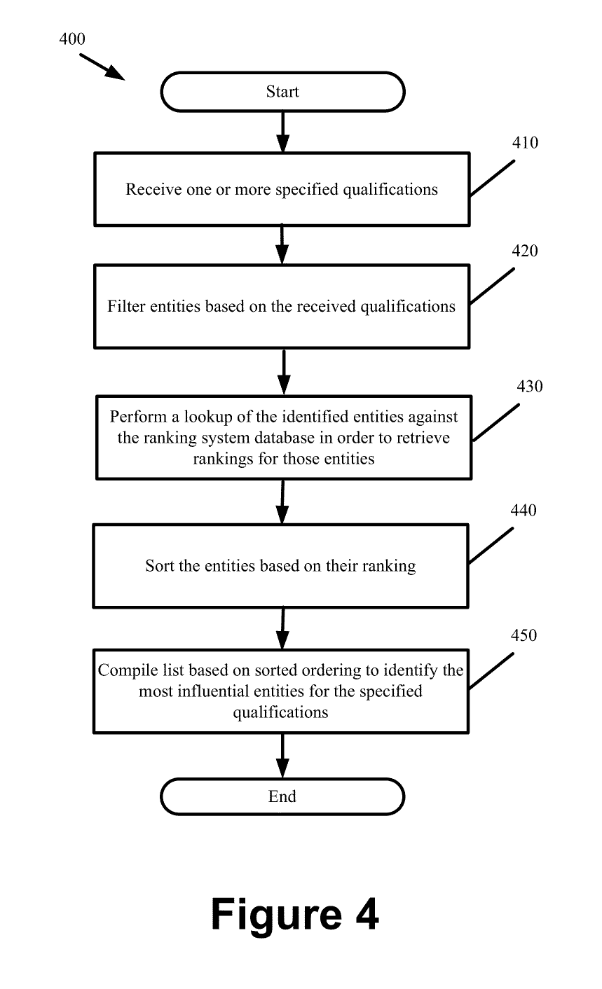

In accordance with some embodiments, FIG. 4 presents a process 400 performed by the ranking system to compile a qualified list by using one or more qualifications to filter ranked entities. The process 400 begins by the ranking system receiving (at 410) one or more specified qualifications. As noted above, the qualifications can include a field, industry, or geographic qualification. Qualifications may also be grouped together such that an industry qualification can be specified in conjunction with a geographic qualification.

The process filters (at 420) the set of available entities based on the received qualifications. In some embodiments, the qualifications are used to formulate a query that is passed to an entity database in order to identify which entities satisfy the specified qualifications. For example, when a qualification specifies a geographic region with the zip code 92165, the process identifies entities that have a presence in or otherwise operate in the 92165 zip code. Similarly, when a qualification specifies the standard industrial classification (SIC) code 6111, the process identifies entities that are involved in the corresponding industry represented by the SIC code. In some embodiments, the entities satisfying the specified qualifications are identified by a unique identifier (e.g., DUNs number, EID, or social security number). The process then performs (at 430) a lookup of the identified entities against the ranking system database in order to retrieve rankings for the entities satisfying the specified qualifications. The process sorts (at 440) the entities based on their ranking and the process compiles (at 450) a list based on the sorted ordering to identify who the most influential entities for the specified qualifications are.

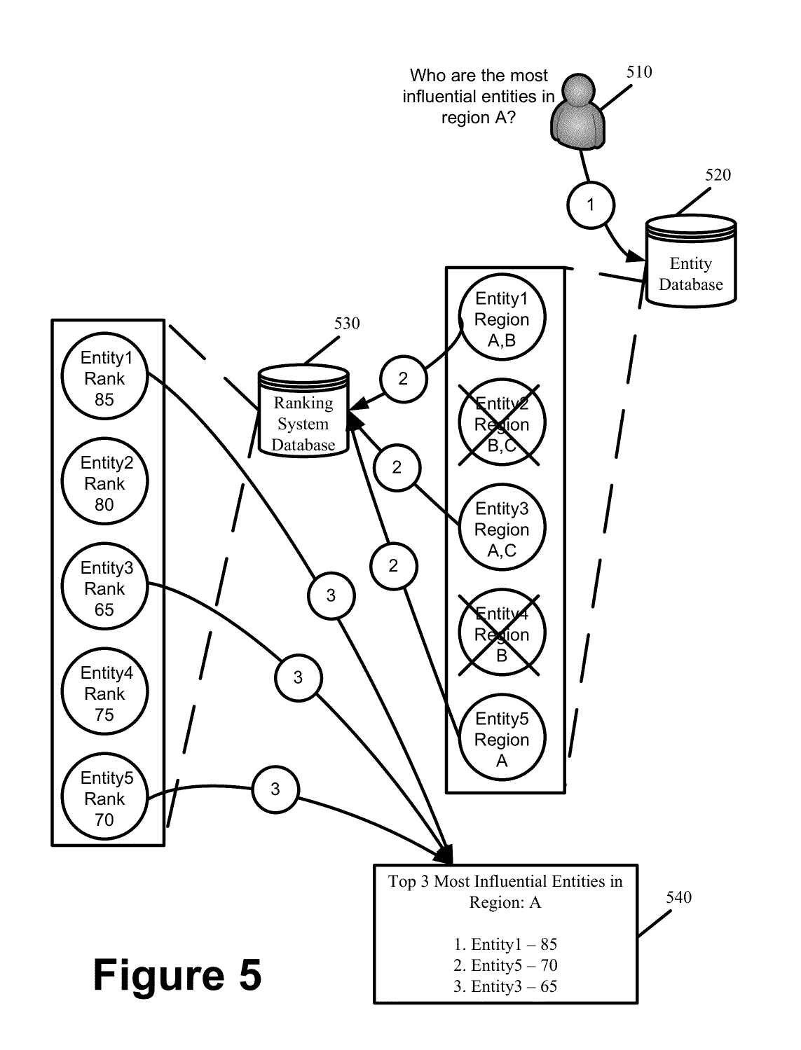

FIG. 5 conceptually illustrates compiling a qualified list by using one or more qualifications to filter ranked entities in accordance with some embodiments. FIG. 5 illustrates user 510, entity database 520, and ranking system database 530. In this figure, it is assumed that the entity database 520 is part of a platform that the ranking system database 530 is integrated with either locally or remotely. The ranking system is omitted from this figure for purposes of simplicity.

As shown, the user 510 specifies a qualification that is passed to the entity database 520. The qualification queries the entity database 520 to identify which entities satisfy the specified qualification. Identification information associated with the qualified entities is then passed to the ranking system database 530 to identify the ranking for each qualified entity. In some embodiments, the identification information comprises a unique identifier such as the DUNS number or EID. The ranking system database 530 returns the rankings for the qualified entities. The rankings are then sorted and compiled into list 540. Based on the qualification specified by the user 510, list 540 identifies the top three most influential entities in the qualified geographic region.

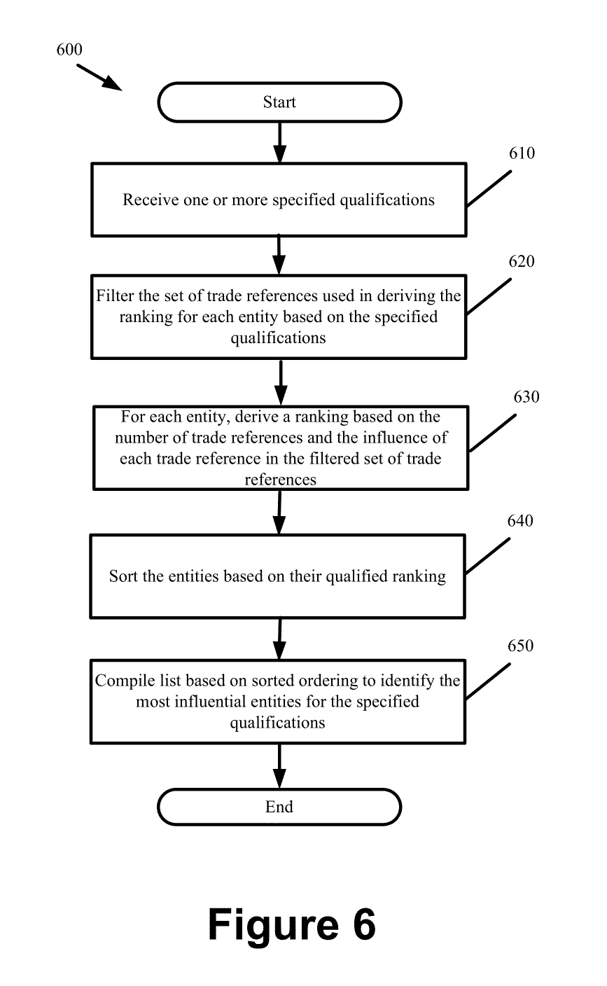

In accordance with some embodiments, FIG. 6 presents a process 600 performed by the ranking system to compile a qualified list based on the application of one or more qualifications to the trade references of the entities. Process 600 produces the qualified list by deriving qualified rankings for the entities in the entity database.

The process 600 begins when the ranking system receives (at 610) one or more specified qualifications. For each entity in the ranking system database, the process derives a qualified ranking based on the specified qualifications. In some embodiments, a qualified ranking is derived by (1) filtering (at 620) the set of trade references used in deriving the overall ranking based on the specified qualifications and (2) deriving (at 630) a ranking based on the number of trade references and the influence of each trade reference in the filtered set of trade references. As earlier noted, some qualifications that can be specified include a field, industry, and geographic qualifications. A field qualification filters the trade references from which the ranking of the particular entity is derived to include those trade references that operate within one or more specified fields of business. An industry qualification filters the trade references from which the ranking of the particular entity is derived to include those trade references that are associated with one or more specified industries. A geographic qualification filters the trade references from which the ranking of the particular entity is derived to include those trade references that operate within one or more specified geographic regions.

The resulting qualified rankings are then sorted (at 640) and compiled (at 650) into a list. The compiled list will include different entities in a different ordering than the list compiled according to the process 400 even when the same qualifications are specified. This is because the qualifications are applied in process 400 to filter the ranked entities to produce a subset of entities that satisfy the specified qualifications, whereas for process 600, the qualifications are applied to the trade references of each entity such that the qualified ranking for a given entity is derived from the trade references of that given entity that satisfy the specified qualifications. For example, when a qualification specifies the geographic region 91625, the trade references for the entities are filtered to include only those trade references that have a presence in or otherwise operate in that geographic region. Then based on the remaining trade references, the rankings for the entities are recomputed. In this example, the entity with the greatest number of trade references operating in the 91625 zip code that also have the highest rankings will have the highest qualified ranking. This is indicative of an entity that is largely influential in the 91625 zip code as it has many contacts in that geographic region that are influential in that geographic region. Entities that have no trade references in the 91625 zip code will be ignored and no qualified ranking will be computed for such entities.

In some embodiments, the compiled lists are tangible commodities of the ranking system. The ranking system can restrict access to the lists or compile custom lists on a onetime fee or subscription basis. In some embodiments, the compiled lists are used to identify actions that can be performed by an entity to improve its ranking. One such action is to transact with a trade reference that is used by other highly ranked entities or to transact with highly ranked entities. Such a trade reference can improve efficiency, quality, credibility, and exposure for an entity. Another action is to identify new areas of opportunity. Specifically, when the highest ranked entities for a particular qualified list include only small business entities, then an opportunity may be identified for one to enter.

In some embodiments, the ranking system is comprised of an interface, ranking engine, and database. Some or all of these components are embodied as software applications or processes that execute on one or more physical computing devices. Collectively, the components transform general purpose computing resources of the computing devices to implement and perform the specified automatic entity ranking and qualified list generation described above. In other words, the computing devices on which the ranking system executes comprise general purpose processors, random access memory, non-volatile storage, and network resources that are transformed by the components of the ranking system into one or more specific purpose machines that automatedly rank entities and compile different qualified lists based on the derived rankings. Some of the tangible results produced by the ranking system include the entity rankings and the compiled qualified lists that can be sold as commodities to interested entities.

The interface communicably couples the ranking system to one or more platforms. Through the interface, the ranking system receives the identification information for the entities that are to be ranked and the specified qualifications for the qualified lists that are to be generated. Accordingly, in some embodiments, the interface generates various interactive graphical user interfaces (GUIs) that obtain the user information and that also present rankings and qualified lists to various users. These interfaces are Internet accessible by directing the browser or other application of a network enabled device to a domain name of the ranking system or the platform in which the ranking system is integrated with. Additionally, the interface communicably couples the ranking system to an entity database, credit scoring database, and credibility scoring database of the integrated platform or a third party platform.

The ranking engine is the component that derives the entity ranks in the manners described above. The ranking engine also compiles the qualified lists automatedly or on-demand. The ranking engine utilizes the database to store the derived rankings for the entities and the qualified lists. In some embodiments, the database can be integrated as part of an entity database such that the database stores identification and classification information about the various entities including the trade references for the entities.

Many of the above-described processes and components are implemented as software processes that are specified as a set of instructions recorded on a computer-readable storage medium (also referred to as computer-readable medium). When these instructions are executed by one or more computational element(s) (such as processors or other computational elements like ASICs and FPGAs), they cause the computational element(s) to perform the actions indicated in the instructions. Computer and computer system are meant in their broadest sense, and can include any electronic device with a processor including cellular telephones, smartphones, portable digital assistants, tablet devices, laptops, and servers. Examples of computer-readable media include, but are not limited to, CD-ROMs, flash drives, RAM chips, hard drives, EPROMs, etc.

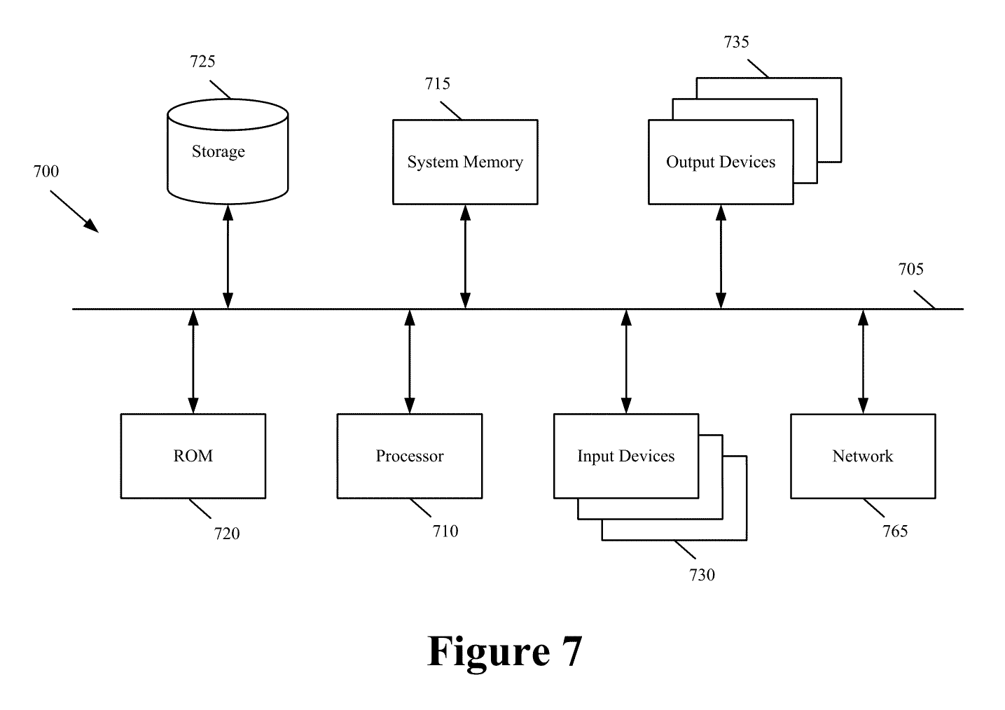

FIG. 7 illustrates a computer system with which some embodiments are implemented. Such a computer system includes various types of computer-readable mediums and interfaces for various other types of computer-readable mediums that implement the various processes, modules, and engines described above for the ranking system. Computer system 700 includes a bus 705, a processor 710, a system memory 715, a read-only memory 720, a permanent storage device 725, input devices 730, and output devices 735.

The bus 705 collectively represents all system, peripheral, and chipset buses that communicatively connect the numerous internal devices of the computer system 700. For instance, the bus 705 communicatively connects the processor 710 with the read-only memory 720, the system memory 715, and the permanent storage device 725. From these various memory units, the processor 710 retrieves instructions to execute and data to process in order to execute the processes of the invention. The processor 710 is a processing device such as a central processing unit, integrated circuit, graphical processing unit, etc.

The read-only-memory (ROM) 720 stores static data and instructions that are needed by the processor 710 and other modules of the computer system. The permanent storage device 725, on the other hand, is a read-and-write memory device. This device is a non-volatile memory unit that stores instructions and data even when the computer system 700 is off. Some embodiments of the invention use a mass-storage device (such as a magnetic or optical disk and its corresponding disk drive) as the permanent storage device 725.

Other embodiments use a removable storage device (such as a flash drive) as the permanent storage device Like the permanent storage device 725, the system memory 715 is a read-and-write memory device. However, unlike storage device 725, the system memory is a volatile read-and-write memory, such as random access memory (RAM). The system memory stores some of the instructions and data that the processor needs at runtime. In some embodiments, the processes are stored in the system memory 715, the permanent storage device 725, and/or the read-only memory 720.

The bus 705 also connects to the input and output devices 730 and 735. The input devices enable the user to communicate information and select commands to the computer system. The input devices 730 include any of a capacitive touchscreen, resistive touchscreen, any other touchscreen technology, a trackpad that is part of the computing system 700 or attached as a peripheral, a set of touch sensitive buttons or touch sensitive keys that are used to provide inputs to the computing system 700, or any other touch sensing hardware that detects multiple touches and that is coupled to the computing system 700 or is attached as a peripheral. The input device 730 also include alphanumeric keypads (including physical keyboards and touchscreen keyboards), pointing devices (also called “cursor control devices”). The input devices 730 also include audio input devices (e.g., microphones, MIDI musical instruments, etc.). The output devices 735 display images generated by the computer system. The output devices include printers and display devices, such as cathode ray tubes (CRT) or liquid crystal displays (LCD).

Finally, as shown in FIG. 7, bus 705 also couples computer 700 to a network 765 through a network adapter (not shown). In this manner, the computer can be a part of a network of computers (such as a local area network (“LAN”), a wide area network (“WAN”), or an Intranet, or a network of networks, such as the internet. For example, the computer 700 may be coupled to a web server (network 765) so that a web browser executing on the computer 700 can interact with the web server as a user interacts with a GUI that operates in the web browser.

As mentioned above, the computer system 700 may include one or more of a variety of different computer-readable media. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ZIP® disks, read-only and recordable blu-ray discs, any other optical or magnetic media, and floppy disks.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A particular computer system including one or more processors and non-transitory computer-readable memory, the particular computer system performing a computer-implemented method for automatedly ranking a particular person or business amongst a plurality of other persons or businesses, the computer-implemented method comprising:
obtaining, at the particular computer system, a set of trade references for the particular person or business, each trade reference of the set of trade references comprising another person or business that attests to the creditworthiness and reputation of the particular person or business as a result of having engaged in a verifiable commercial transaction with the particular person or business;
computing, by operation of the one or more processors, a first rank component score based on a number of trade references in the obtained set of trade references, wherein the first rank component score comprises a numeric value quantifying a rank based on the number of trade references;
computing, by operation of the one or more processors, a second rank component score based on influence of each trade reference of the set of trade references; and
deriving the ranking for the particular person or business based on the first rank component score and the second rank component score.

2. The computer-implemented method of claim 1 further comprising adjusting the first rank component score according to a number of employees operating under the particular person or business.

3. The computer-implemented method of claim 1 further comprising verifying the set of trade references by confirming that the particular person or business has engaged in at least one commercial transaction with each trade reference of the set of trade references.

4. (canceled)

5. The computer-implemented method of claim 1 further comprising deriving a ranking for each particular trade reference of the set of trade references, wherein deriving the ranking for a particular trade reference of the set of trade references is based in part on influence of trade references of the particular trade reference.

6. The computer-implemented method of claim 1 further comprising deriving a ranking for each particular trade reference of the set of trade references based on at least one of a credit score and a credibility score of the particular trade reference.

7. The computer-implemented method of claim 1 further comprising deriving a preliminary ranking for the particular person or business based on at least one of a credit score and a credibility score computed for the particular person or business.

8. The computer-implemented method of claim 7 further comprising updating the preliminary ranking based on the first rank component score and the second rank component score used in deriving the ranking of the particular person or business.

9. The computer-implemented method of claim 1 further comprising repeating said obtaining, computing, computing, and deriving for each person or business of the plurality of persons or businesses in order to derive a ranking for each of the plurality of persons or businesses.

10. The computer-implemented method of claim 9 further comprising producing a listing based on the derived rankings, the listing identifying a set of persons or businesses of the plurality of persons or businesses with a ranking in a specified range.

11. The computer-implemented method of claim 1 further comprising providing an interface by which the particular person or business submits the set of trade references.

12. A non-transitory computer-readable storage medium with an executable program stored thereon for automatedly ranking a particular person or business, wherein the program instructs a microprocessor to perform sets of instructions for:
computing a preliminary ranking for the particular person or business based on a credit score of the particular person or business;
identifying a plurality of trade references comprising other persons or businesses that attest to the creditworthiness and reputation of the particular person or business as a result of having engaged in a prior commercial transaction with the particular person or business;
receiving a set of filters specifying at least one qualification qualifying trade references from the plurality of trade references that can be used in deriving the ranking of the particular person or business;
extracting a set of trade references from the plurality of trade references that satisfy the at least one qualification specified for the set of filters by filtering from the set of trade references any trade reference of the plurality of trade references that does not satisfy the at least one qualification;
producing a ranking of the particular person or business by adjusting the preliminary ranking of the particular person or business based on a rank of each trade reference in the filtered set of trade references; and
presenting the ranking to the particular person or business through an online interface.

13. The non-transitory computer-readable medium of claim 12, wherein the program further comprises a set of instructions for compiling a listing identifying how the particular person or business ranks compared to a plurality of other persons and businesses that satisfy the at least one qualification specified for the set of filters.

14. The non-transitory computer-readable medium of claim 12, wherein the set of filters specify at least one of (i) a geographic qualification identifying a specific geographic region for the set of trade references and (ii) an industry qualification identifying a specific industry of operation for the set of trade references.

15. The non-transitory computer-readable medium of claim 12, wherein the set of instructions for producing the ranking of the particular person or business comprises a set of instructions for (i) computing a first rank component score based on a number of trade references within the set of trade references, (ii) computing a second rank component score based on a rank of each trade reference within the set of trade references, and (iii) adjusting the preliminary ranking of the particular person or business based on the first rank component score and the second rank component score.

16. The non-transitory computer-readable medium of claim 12, wherein the program further comprises a set of instructions for presenting an interface comprising at least one interactive field for the particular person or business to define at least one of (i) a geographic filter to restrict the set of trade references to include trade references that operate within a geographic region that is specified for the geographic filter and (ii) an industry filter to restrict the set of trade references to include trade references that operate within an industry classification that is specified for the industry filter.

17. A computer system including one or more processors and non-transitory computer-readable memory, the computer system performing a computer-implemented method for identifying rankings of persons or businesses according to different user specified filters, the computer-implemented method comprising:
receiving, at the computer system, a request for a listing of persons or businesses (i) ranking within a user specified range and (ii) satisfying a user specified filter specifying at least one qualification for persons or businesses to be included in the listing;
identifying, by operation of the one or more processors, a set of persons or businesses from a plurality of persons or businesses that satisfy the at least one qualification for the filter;
obtaining, at the computer system, a set of trade references for each particular person or business of the set of persons or businesses, each trade reference of the set of trade references for the particular person or business comprising another person or business that attests to the creditworthiness and reputation of the particular person or business as a result of having engaged in a verifiable commercial transaction with the particular person or business;
ranking, by operation of the one or more processors, each particular person or business of the set of persons or businesses based on a number of trade references that are obtained for the particular person or business and based on an influence of each trade reference that is obtained for the particular person or business;
sorting the set of persons or businesses based on a ranking of each particular person or business of the set of persons or businesses; and
presenting a listing identifying a subset of the set of persons or businesses ranking in the user specified range.

18. The computer-implemented method of claim 17, wherein the at least one qualification for the filter comprises a geographic qualifier specifying a geographic region and wherein identifying the set from the plurality of persons or businesses comprises identifying the set of persons or businesses from the plurality of persons or businesses that are located within the geographic region of the filter.

19. The computer-implemented method of claim 17, wherein the at least one qualification for the filter comprises an industry qualifier specifying an industry and wherein identifying the set from the plurality of persons or businesses comprises identifying the set of persons or businesses within the plurality of persons or businesses that operate in the industry specified for the industry qualifier of the filter.

20. (canceled)

21. The computer-implemented method of claim 2 further comprising adjusting the first rank component score according to a number of years that the particular person or business has been operating.

22. The computer-implemented method of claim 1 further comprising modifying the ranking for the particular person or business based on at least one of a credit score and credibility score of the particular person or business.
